(19) United States
(12) Patent Application Publication
(10) Pub. No.: US 2026/0359723 A1
(43) Pub. Date: Nov. 12, 2026

(54) Adaptive Probably Approximate Learning Networks

(71) Applicant: Vital Statistics Incorporated, Boston, MA (US)

(72) Inventor: Parama Pal, Cambridge, MA (US)

(73) Assignee: Vital Statistics Incorporated, Boston, MA (US)

(21) Appl. No.: 19/642,760

(22) Filed: Apr. 9, 2026

Related U.S. Application Data
(60) Provisional application No. 63/786,109, filed on Apr. 9, 2025.

(51) Int. Cl. G06N 20/00

(52) U.S. Cl. CPC G06N 20/00

(57) ABSTRACT

Machine learning systems, architectures, and methods, capable of varying and adapting topologies including during and after training. The systems and methods analyze information-theoretic measures of information processing by the components of a framework. The systems and methods may also have a set of constraints related to such theoretic measures of information processing. The systems and methods employ such measures to improve or optimize the topology of the framework being used.

### RELATED APPLICATIONS

This application claims priority to and the benefit under 35 U.S.C. 119(e) of US Provisional Application 63/786109 filed 9 Apr. 2025 and entitled “PAL Network” and naming Parama Pal as inventor, the contents of which are incorporated by reference in their entirety.

### BACKGROUND OF THE INVENTION

Current machine learning approaches across various paradigms, including but not limited to neural networks, probabilistic models, symbolic reasoning frameworks, and other learning systems employing various optimization paradigms including reinforcement learning, predominantly employ fixed architectural topologies that are predetermined prior to operational deployment and remain largely static during execution. While these systems can adjust parameters through various optimization techniques, their fundamental structural organization typically remains unchanged. This architectural rigidity presents significant limitations that restrict adaptability, generalization capability, and information encoding efficiency, particularly when addressing complex, dynamic, or previously unencountered problem domains across diverse fields of application.

Additionally, existing machine learning systems which comprise models with essentially static architectural topologies can be less efficient than adequate for addressing the problem domain. In particular, such machine learning systems may consume substantially more memory and computational resources than the application requires. Because modern machine learning models are predominantly memory-bound in performance, inefficient use of memory directly limits the speed, scalability, and deployability of these systems. Inefficient use of computational resources also increases operational cost, particularly in cloud computing environments where cost is proportional to resource usage over time. Further, as a consequence, such inefficiency results in excessive power consumption. This is a significant issue because machine learning systems have been successful and are proliferating across the technical systems and devices used in everyday operations. As such systems become more common and more extensively used, these inefficiencies will needlessly burden the limited resources present in publicly accessible infrastructure in spaces such as computational power, lighting, heating and air conditioning, and other power demands.

Attempts to address the rigidity of fixed network architectures have included neural architecture search (NAS) methods and related automated machine learning (AutoML) approaches. These methods typically define a discrete search space of candidate architectures and employ optimization techniques, such as reinforcement learning, evolutionary algorithms, or gradient-based relaxations, to identify high-performing architectures from within that search space. However, NAS and related methods are generally applied as an offline design-phase process: the architecture search is conducted prior to final training and deployment, and the selected architecture remains static during subsequent training and inference operations. The search process itself is computationally expensive, often requiring thousands of GPU-hours to evaluate candidate architectures, and the resulting architecture is fixed once selected. Furthermore, NAS methods typically search within a predefined and bounded architecture space defined by human designers, limiting the range of topological configurations that can be discovered.

Other approaches, such as pruning, knowledge distillation, and quantization, address efficiency by modifying a trained model after the fact or requiring re-training. While these methods can reduce model size and computational cost, they operate on a fixed architectural topology and do not adapt the fundamental structural organization of the network.

Accordingly, there exists a need for systems that can provide the remarkable inferencing power of machine learning systems but do so while utilizing resources efficiently.

### SUMMARY OF THE INVENTION

The systems and methods disclosed herein relate to machine learning systems, architectures, and methods, and more particularly to learning networks capable of varying and adapting topologies including during and after training. In certain embodiments, the systems and methods analyze information-theoretic measures of information processing by the components of a framework. The systems and methods may also have a set of constraints related to such theoretic measures of information processing. The systems and methods employ such measures to improve or optimize the topology of the framework being used, optionally during various operational phases including, pre-training, training, fine-tuning, post-training, inference, and continuous learning. Further optionally, the systems and methods may store certain topology adaptations to retrieve upon encountering conditions resembling past states, to accelerate convergence or reduce entropy.

As is generally known, learning networks such as neural networks typically intake training data and process that training data through the learning network to allow the learning network to develop a prediction model. The prediction model developed by the learning network can, in some cases after training, process input data to make inferences for output to a user. Typically, the prediction model is built upon a framework, such as a neural network type framework, a graph type framework, a reinforcement learning system framework, a probabilistic model and framework, a symbolic reasoning framework or some other type of framework. In typical learning networks, the framework has a static structure (or architecture) with tunable parameters, such as weights or other such features. The learning network builds the prediction model by tuning these tunable parameters until the prediction model can satisfactorily make correct inferences for the input data. As will be described in more detail hereinafter, the systems and methods described herein are Probably Approximate Learning (PAL) networks that are adaptive systems which apply, for example, probably approximately correct (PAC) learning theory, and computational learning theory to modify the topology of the prediction model, in addition to the typical tuning of the tunable parameters of the prediction model. In one embodiment, the modifications to the topology of the framework are continuously made. The systems modify the topology by measuring information-theoretic parameters, such as entropy, Kolmogorov complexity, mutual information, and/or other parameters, and using those parameters and constraint preferences such as desired accuracy to determine modifications to the structure of the prediction model topology that will improve operation.

Typically, the Probably Approximate Learning (PAL) networks described herein incorporate the measures of information-theoretic parameters to guide structural optimization operations, employing component generation and elimination mechanisms to adapt, and adaptively generate, the topology of the prediction model. For example, with a neural network framework-based structure, the systems and methods described herein can employ component generation and elimination by implementing node birth and node death processes, implement processes for connection formation and pruning, and processes for layer or module creation and removal. These processes may evolve and adapt the topology of the prediction model to improve information flow through the prediction model while optionally satisfying multiple operational constraints. Although discussed above with regard to an example of a neural network structure, the processes described herein may be applied to any computational framework structure where dynamic structural adaptation provides benefits in learning efficiency, resource utilization, or generalization capability.

In one embodiment, the PAL network systems described herein are configured to operate two concurrent processes on the same computational substrate. A first process, referred to herein as the inner loop, comprises the standard neural network training or inference process which may include forward propagation of input data through the prediction model, computation of a loss or error metric, and backpropagation of gradients to update the weights and parameters of the prediction model. This inner loop is identical or at least similar to the training or inference process of a conventional neural network and typically employs standard optimization techniques without modification. A second process, referred to herein as the outer loop, typically comprises the PAL system's monitoring, evaluation, and topology modification functions. The outer loop's monitor observes the behavior of the prediction model's components during operation of the inner loop, computes channel clarity vectors as read-only metadata for each component, and compares the computed measures against a set of aggregated constraints. When the outer loop determines that topology modification is warranted, for example, at entropy local minima where the rate of change of topology entropy approaches zero, the topology modifier makes discrete structural changes to the topology of the prediction model, after which the inner loop continues on the modified topology. In one typical embodiment, the outer loop does not modify the mechanism of the inner loop's computation; it modifies only the structure of the topology upon which the inner loop operates.

In one embodiment, the systems described herein also include a foldability analyzer processor that is configured to determine whether a modified topology produced by the topology modifier can be folded for execution across a structure of processors, such as graphics processing units (GPUs), as a set of parallelized tensor operations. As used herein, “folding” refers to the process of mapping an adapted prediction model topology, which may include irregular connectivity patterns, variable-size layers, skip connections, or other non-standard structural features introduced by the adaptive process, onto a regular computational structure that can be expressed as a sequence of dense or structured-sparse matrix operations suitable for parallel execution on available hardware.

The foldability analyzer processor may be configured to evaluate a candidate prediction model topology produced by the topology modifier against a set of hardware-specific foldability constraints. These foldability constraints may include, but are not limited to, whether the connectivity pattern of the adapted topology can be represented as block-structured matrices compatible with the tensor cores or matrix units of the target processors, whether the layer dimensions of the adapted topology align with or may be padded to tile sizes supported by the target hardware, for example, multiples of 8 or 16 for common GPU tensor core configurations, whether the data flow through the adapted topology may be scheduled as a directed acyclic graph of tensor operations without exceeding the memory capacity of the target processor configuration, and whether the adapted topology, when expressed as tensor operations, would achieve a minimum threshold of arithmetic intensity sufficient to utilize the target hardware efficiently rather than being bounded by memory bandwidth.

In one embodiment, the foldability analyzer processor is configured to receive from the topology modifier a candidate adapted topology. The foldability analyzer processor may be configured to first extract the computational graph of the candidate topology, identifying each operation, its input and output dimensions, and the data dependencies between operations. The foldability analyzer is configured to then attempt to decompose the computational graph into a sequence of tensor operations compatible with the target processor configuration. This decomposition may include grouping nodes into layers that can be expressed as matrix multiplications, identifying operations that can be fused, and determining where data must be redistributed across processors in a multi-processor configuration. If the foldability analyzer processor can produce a valid decomposition that satisfies the foldability constraints, the candidate topology is classified as foldable and is added to the space of valid network topologies. If the foldability analyzer cannot produce a valid decomposition, the candidate topology is returned to the topology modifier, typically with diagnostic information indicating which foldability constraints were violated, enabling the topology modifier to adjust the topology of the prediction model and resubmit for analysis.

In a further embodiment, the foldability constraints are integrated into the constraint aggregator such that the topology modifier considers hardware foldability during the topology adaptation process itself, rather than only as a post-adaptation validation step. In this embodiment, the constraint aggregator includes foldability constraints alongside, for example, the entropy threshold, Kolmogorov complexity target, and memory and cost constraints described herein, and the aggregated constraint score reflects the foldability of the topology under adaptation. This integration enables the system to steer topology adaptation toward structures that are both information-theoretically efficient and hardware-deployable, reducing the number of adaptation cycles needed to arrive at a valid, deployable topology.

In one embodiment, the systems described herein may include a probably approximate (PA) processor that is configured to test an operational metric, such as an error or accuracy curve, of a valid (foldable) network topology to determine if its operational metric is sufficiently similar to a target operational metric, as described in further detail herein with respect to the probably approximate analyzer. If the PA processor determines that the operational metric of the foldable adapted topology is sufficiently similar to that of the initial network topology, the foldable adapted topology is confirmed as a member of the space of valid network topologies that can be used as a prediction model for the problem being addressed. In this manner, the system checks that adapted topologies are information-theoretically improved or optimized and constraint-satisfying, but also practically deployable on available hardware.

In one embodiment, the systems and methods described herein provide adaptive learning systems that provide dynamic, self-modifying architectural prediction model topologies that can continuously adapt their topological organization, typically throughout all operational phases. To this end, in certain embodiments, the systems and methods described herein include systems that adapt the topology of a prediction model during training, operation, or other phases of the topology's development and application. The structural framework may, in some embodiment, comprise a model and its topology and its environment including for example explicitly stated constraints.

In one embodiment, the systems and methods described herein adapt the topology of a prediction model such that the PAL Network may determine variable topologies that improve or optimize themselves based on information-theoretic principles. The different topologies can be employed as a space of alternate topologies for the prediction model used for the task. The PAL Network system and methods described herein incorporate processes for measuring information-theoretic parameters of a prediction model, such as for example, neural-inspired framework prediction models, a graph-based framework model, a hybrid symbolic-statistical framework model, or any other machine learning framework, to guide structural optimization. The PAL Network systems and methods may be dynamic, and modify prediction model topolgies continuously to dynamically evolve the structure of the prediction model throughout all operational phases.

In one embodiment the system adapts the prediction model topology by analyzing components of the structural framework (including the prediction model topology) to determine measures, typically information theoretic measures, of operational efficiency of those components. These measures, optionally in combination and a set of constraints, may be used to drive a topology modifier to modify the topology of the trained prediction model. In one embodiment, the prediction model is structured like a neural network having nodes, links and layers. The systems and methods described herein may determine a channel clarity vector for one or more nodes in the prediction model. It may be the case that system determines a channel clarity vector for each node in the neural network prediction model. A channel clarity vector represents, typically in vector form, the clarity of the channel between one node and a neighboring node, for communicating information through that channel (or link) as conventionally related to mutual information.

For example, in the case where the prediction model of the learning network is a neural-inspired architecture, such as a neural network, the topology may include multiple layers of interconnected processing elements, called nodes (or neurons). The systems and methods described herein can employ the measures of efficacy and other constraints to adapt the topology to one that is more suited to the application, or any application. Further, it is a realization of the inventor that this topology is typically embodied as a programming structure, typically realized as a set of executable software instructions that define the weights and interconnections and that carry out the computations given these weights and interconnections. These software instructions are loaded into a program memory and executed across a processing unit, commonly a graphics processing unit (GPU). As such, the structure of the neural network (its framework and topology) may be changed by changing the programming instructions and reloading altered programming instructions to execute across the GPU. To that point, the systems and methods described herein include a topology modifier that can alter these programming instructions to adapt the realization over the processors of the topology of the neural network.

In one embodiment, the topology modifier includes a monitor which will measure parameters of system organization and efficiency of components within the neural network. Such parameters of organization and efficiency can include, in one example, a measure of entropy for a node within the neural network. In one such example, the monitor analyzes nodes in the framework to make a measure of entropy for that node. In typical embodiments, measures of entropy can be understood as Shannon defined entropy and measures of the uncertainty of a random variable, or equivalently the average information produced by a source of messages. See Shannon, “A Mathematical Theory of Communication,” (1948), which sets out that entropy measures the uncertainty associated with a random variable before the message is known. In the systems described herein, the monitor can measure entropy of nodes and can have an Entropy Threshold that establishes upper bounds on permissible system entropy, thereby directing the network to maintain information efficiency. It is noted that the channel clarity vector and the information-theoretic measures computed by the monitor are typically read-only observations of the node's behavior. The channel clarity vector is generally not a learnable parameter of the neural network; it typically does not participate in the forward pass, is not included in the loss function, and is not updated by backpropagation or any optimizer. Rather, the monitor computes the channel clarity vector by observing the node's output distribution, its relationship to neighboring nodes, and the compressibility of its learned weights. The node itself typically operates as a standard neural network node at all times. The channel clarity vector is metadata maintained by the PAL system's monitor for the purpose of informing topology modification decisions.

The topology modifier can further have a topology modifier. The topology modifier analyzes the determined entropy parameter for the example node and compares that information to the entropy threshold. In one embodiment, the network modifier may determine that the node provides little to no value within the neural network. The network modifier may institute a node elimination (node-death) process that will remove the node from the existing topology of the neural network. As discussed above, removing the node may include changing the executable software instructions that create the computational procedures of the neural network framework across the GPU's. Typically, it is understood by eliminating a node, the system described herein causes the neural network to run more efficiently. The systems and methods described herein can load the modified or adapted framework of the neural network onto the GPU and execute that more efficient system.

Optionally and preferably, the systems and methods described herein further include a probably approximate (PA) processor (or analyzer) configured to analyze the adapted topology and determining whether the adapted topology preserves sufficient representational capacity relative to the initial topology. The probably approximate analyzer provides a formal criterion for determining when a more efficient adapted topology may replace a less efficient initial topology without unacceptable loss of prediction accuracy. The term “probably approximate” as used herein is inspired by and related to the Probably Approximately Correct (PAC) learning framework established by Valiant (1984), which provides formal bounds on the number of training samples required for a learning algorithm to achieve, with probability at least (1-δ), a generalization error of at most ε. The probably approximate analyzer described herein extends this conceptual framework to the comparison of two network topologies by establishing that the adapted topology is, with probability at least (1-δ), within an accuracy tolerance ε of the initial topology's performance.

In one embodiment, the probably approximate analyzer is configured to compare learning curves or error curves generated for the initial topology and the adapted topology. A learning curve, as used herein, is a function that maps the number of training iterations or training samples to a measure of prediction accuracy or error for a given network topology. The probably approximate analyzer is configured to generate or receive a learning curve L_init(n) for the initial topology and a learning curve L_adapt(n) for the adapted topology, where n represents the number of training iterations or samples and the output is a measure of error or loss.

In one embodiment, the probably approximate analyzer is configured to compute a divergence measure between the two learning curves. In one embodiment, the divergence measure is a bounded area divergence defined as:

D(L_init, L_adapt)=(1/N)·Σ|L_adapt(n)−L_init(n)| for n=1 to N

where N is the total number of evaluation points. In an alternative embodiment, the divergence measure is a maximum pointwise divergence defined as the supremum of |L_adapt(n)−L_init(n)| over all n in the evaluation range. In a further alternative embodiment, the divergence measure is a statistical divergence computed using a paired statistical test, such as a paired t-test or Wilcoxon signed-rank test, applied to paired error measurements from the two topologies evaluated on the same test data.

The probably approximate analyzer may be configured to determine that the adapted topology is probably approximate to the initial topology if the computed divergence measure satisfies:

D(L_init, L_adapt)≤ε with confidence≥(1-δ)

where ε is an accuracy tolerance parameter and δ is a confidence parameter, both of which may be set by the constraint aggregator or provided as system configuration parameters. The accuracy tolerance ε establishes how much degradation in prediction accuracy is acceptable for the efficiency gains provided by the adapted topology. The confidence parameter δ establishes the probability with which the analyzer's determination may be incorrect. In typical embodiments, ε may be set to a value between 0.01 and 0.10 (representing 1% to 10% acceptable accuracy degradation) and δ may be set to a value between 0.01 and 0.10 (representing 90% to 99% confidence).

In one embodiment, the probably approximate analyzer further computes a representational capacity ratio defined as the ratio of the effective representational capacity of the adapted topology to the effective representational capacity of the initial topology. The effective representational capacity may be estimated using information-theoretic measures such as the total mutual information between input and output across the network, the effective number of parameters (accounting for redundancy identified by the channel clarity vectors), or the minimum description length of the function class implementable by the topology.

In one aspect, the systems and methods described herein, include a method for providing a self-adapting learning network, comprising developing a prediction model having an initial topology, measuring accuracy characteristics of the prediction model having the initial structure, measure operating characteristics of the topology of the prediction model during training, evaluate the measured operating characteristics to determine if the measured operating characteristics indicate the initial structure may achieve similar accuracy characteristics if the initial structure is modified to an alternate structure, and modifying the topology of the prediction model to have the alternate structure.

Optionally, the method may include an initial topology including a plurality of nodes and links that are arranged by operation of a self-learning training process. Further optionally, measuring operating characteristics includes measuring information-theoretic parameters, constraint satisfaction parameters, and performance parameters. Further, measuring information-theoretic parameters may include measuring entropy parameters for the topology.

Further, the method may when measuring accuracy characteristics of the prediction model include measuring for the initial structure a bounded measure of generalization error, a bounded measure of training sample requirements, and a bounded measure of probabilistic accuracy.

Further, the method may when modifying the topology of the prediction model to have the alternate structure may do such modifying during a training phase, a validation phase, and an inference phase and continuously through operation.

Further, the method may when measuring operating parameters include measuring parameters that measure information flow across the topology and using these measurements to drive adaptation. Further, the method may when adapting the topology to an alternate structure include adding, modifying, and removing structural components of the topology in response to the determined measures. Further, the method may include aggregating and balancing multiple constraints, for controlling the adaption of the topology.

Further and optionally, the method may include storing previously adapted topologies and may include selecting, compressing, storing, retrieving, and deploying the stored adapted topologies and evaluating when to revert to prior topology.

In a further aspect, the methods include a method for monitoring information processing of a learning network, comprising analyzing the learning network to identify a plurality of structural levels of the learning network including individual components, subsystems and a global system, monitoring information processing over these structural levels, integrating the monitored measures of information processing made over the different structural levels to develop a network adaption process measure.

In a further aspect, the methods include methods for Subsystem-Level Learning Formulations, comprising monitoring learning progress at multiple system levels, which may demonstrate stabilization of information-theoretic measures at various levels. The methods may further comprise an adaptation rate control mechanisms for dynamically adjusting adaptation frequency or adaption magnitude to ensure system stability while maintaining responsiveness to changing conditions.

In one aspect, it can be understood that in some embodiments, the PAL network employs a dual-loop architecture and may operate two concurrent processes on a neural network substrate. An inner loop performs processes of standard neural network computation (forward pass, backpropagation, weight updates) without modification. An outer loop monitors information-theoretic properties of the network's components, compares them against aggregated constraints, and is configured to make discrete structural modifications to the topology. The inner loop's computational mechanism is, in a typical embodiment, not altered; only the structure upon which it operates changes.

In one aspect, it can be understood that in some embodiments, the PAL network employs channel clarity vectors as read-only metadata. Typically, the PAL network's monitor computes, for one or more or each component of the prediction model, a channel clarity vector comprising information-theoretic measures (entropy, mutual information, estimated Kolmogorov complexity) that characterize the component's information transfer efficiency. Typically, these vectors are read-only observations and they are not learnable parameters, do not participate in the forward pass or loss computation, and are not updated by backpropagation.

In one aspect, it can be understood that in some embodiments, the PAL network provides a variable self-updating topology: In some embodiments, the PAL network requires no fully predefined structure at initialization and can dynamically modify its architectural organization through component generation and elimination, connection formation and removal, module creation and pruning, hierarchical reorganization, and other structural modifications.

In one aspect, it can be understood that in some embodiments, the PAL network employs learning-theoretic frameworks including Probably Approximately Correct (PAC) learning, statistical learning theory, Bayesian inference, information theory, and other mathematical frameworks that support learning from data.

In one aspect, it can be understood that in some embodiments, the PAL network employs Learning processes within the PAL network that may be defined and guided by information-theoretic principles including entropy minimization and stabilization, mutual information maximization, minimum description length, variational inference, and other information-based metrics.

In one aspect, it can be understood that in some embodiments, the PAL network employs hierarchical multi-scale adaptation. In some embodiments, subsystems and components characterize and improve/optimize their own information processing, with adaptation occurring at component, subsystem, and global scales simultaneously, potentially using different metrics at different scales.

In one aspect, it can be understood that in some embodiments, the PAL network employs constraint-driven structural evolution wherein architectural evolution is guided by aggregated constraints including information-theoretic bounds, computational resource limitations, accuracy requirements, temporal restrictions, power consumption, memory usage, hardware foldability, interpretability requirements, and other operational parameters.

In one aspect, it can be understood that in some embodiments, the PAL network employs dynamic component management and the PAL network's topology modifier implements processes for creating, modifying, and removing structural components during any operational phase, including training, validation, inference, and deployment, with adaptation triggered at entropy local minima rather than continuously.

In one aspect, it can be understood that in some embodiments, the PAL network incorporates theoretical frameworks to establish bounds or guarantees on system performance, including the probably approximate criterion for determining when an adapted topology may replace an initial topology.

In one aspect, it can be understood that in some embodiments, the PAL network maintains a distributed database of previous topologies, stored as compressed representations, enabling retrieval and reinstatement of effective past configurations when current conditions warrant.

In one aspect, it can be understood that in some embodiments, the PAL network includes a foldability analyzer that determines whether adapted topologies can be decomposed into parallelizable tensor operations for execution on target hardware configurations.

In one aspect, it can be understood that in some embodiments, because the PAL network system's monitoring and topology modification operate as a read-only outer loop that does not interfere with the neural network's inner loop computation, all standard neural network techniques (including dropout, batch normalization, attention mechanisms, residual connections, and any gradient-based optimizer) function without modification within a PAL network.

In one aspect, it can be understood that in some embodiments, the PAL network may be applied across diverse domains including natural language processing, computer vision, autonomous systems, scientific discovery, healthcare, financial modeling, robotics, and other fields benefiting from machine learning approaches.

In one aspect, it can be understood that in some embodiments, the PAL network implements structural changes at various temporal scales, from rapid adaptation for immediate inputs to gradual evolution over extended operational periods.

As will be more clear from the following detailed description, the systems and methods provide variable self-updating architecture. The systems and methods in some embodiments require no fully predefined structure when initialization begins and can dynamically modify its architectural organization through various structural adaptation mechanisms, which may include but are not limited to component generation and elimination, connection formation and removal, module creation and pruning, hierarchical reorganization, or other structural modifications.

Further, preferably the systems and methods employ learning theoretical frameworks, including but not limited to Probably Approximately Correct (PAC) learning, statistical learning theory, Bayesian inference, information theory, or other mathematical processes that support learning from data.

As will be more clear from the following detailed description, the systems and methods may use learning processes that may be defined and guided by information-theoretic principles, including but not limited to entropy minimization/stabilization, mutual information maximization, minimum description length, variational inference, or other information-based metrics.

As will also be more clear from the following detailed description, the systems and methods may implement hierarchical adaptation where subsystems or components can characterize and optimize their own information processing, with adaptation occurring at multiple scales simultaneously and potentially using different metrics at different scales.

As will also be more clear from the following detailed description, the systems and methods may employ a constraint-driven structure where the architectural or structural evolution may be guided by various constraints including but not limited to information-theoretic bounds, computational resource limitations, accuracy requirements, temporal restrictions, power consumption, memory usage, interpretability requirements, or other operational parameters.

As will also be more clear from the following detailed description, the systems and methods may employ dynamic component management wherein such systems and methods may implement processes for creating, modifying, and removing structural components during any operational phase, with adaptation potentially triggered by internal mechanisms, external inputs, performance metrics, or combinations thereof.

As will also be more clear from the following detailed description, the systems and methods may employ theoretical bounds and thresholds and such systems and methods in certain embodiments may incorporate various theoretical frameworks to establish bounds or guarantees on system performance, including but not limited to information-theoretic measures, computational complexity metrics, statistical confidence intervals, or other formalized constraints.

As will also be more clear from the following detailed description, the systems and methods in certain embodiments may include a distributed architectural memory that may maintain records of previous architectural structures in various ways, potentially including distributed storage across components, dedicated memory structures, compressed representations, or other mechanisms that enable reusing or reanalyzing beneficial or improved structures.

As will also be more clear from the following detailed description, the systems and methods in certain examples, may provide cross-domain applicability and may be applied across diverse application domains including but not limited to natural language processing, computer vision, autonomous systems, scientific discovery, healthcare, financial modeling, robotics, or any field benefiting from machine learning approaches.

As will also be more clear from the following detailed description, the systems and methods in certain embodiments may apply across multiple adaptation timescales and may implement structural changes at various temporal scales, from rapid adaptation for immediate inputs to gradual evolution over extended operational periods, potentially with different mechanisms operating at different timescales.

### BRIEF DESCRIPTION OF DRAWINGS

The systems and methods described herein are set forth in the appended claims. However, for purpose of explanation, several embodiments are set forth in the following figures.

FIG. 1 is a block diagram of one embodiment of an end-to-end system pipeline for implementing certain adaptive learning frameworks disclosed herein

FIG. 2 depicts another embodiment of the systems described herein for PAL Network systems that adapt, optionally continuously, the topology of a prediction model;

FIG. 3 depicts a process for setting constraints for a network adaptation process;

FIGS. 4A and 4B depict a process for measuring characteristics of a topology and employing channel clarity vectors during adaption;

FIG. 5 depicts an example process of developing a topology for a framework for a neural network during a training phase;

FIG. 6 depicts a flowchart depicting a high-level training process for the adaptive learning network, in accordance with various embodiments;

FIG. 7 depicts a flowchart depicting an adaptive tuning process within the learning network system, in accordance with various embodiments;

FIG. 8 depicts an example of a network's topology evolving over multiple training iterations;

FIG. 9 depicts pictorially a learning network that stores and recalls learned network topologies in a memory;

FIG. 10 depicts training curves and test curves for an initial model to determine measures for testing whether an adapted network is a probably approximate network; and

FIG. 11 depicts a flow chart of one process for checking folding with topology modification.

### DETAILED DESCRIPTION

In the following description, numerous details are set forth for purpose of explanation and illustration. In particular, the following description discusses embodiments of probably approximate learning (PAL) networks and systems for creating and putting to work such learning networks. As will be described in further detail these systems and methods provide, among other things, Probably Approximate Learning (PAL) networks that adaptively analyze and adapt the topology of the framework of the prediction model being generated and create a space of the possible framework topologies that can solve the problem with an acceptable level of accuracy. The PAL network allows for selecting constraints to be used when adaptively analyzing the topologies. These constraints can direct the adaption process to achieve a space of acceptable topologies that can solve the problem being addressed, while operating within the limits set by the constraints. Although, most of the illustrated embodiments presented hereinafter are described with reference to systems, it will be understood that in another aspect the invention provides methods for creating probably approximate learning networks and using such methods for developing prediction models. In another aspect, the systems and methods described herein include methods for manufacturing prediction models that are more efficient and could be extended across multiple processing units, typically GPUs. Other realizations will be apparent from review of the illustrated embodiments presented herein.

In one embodiment, the PAL network system adapts the topology of the framework continuously, including during training, validation and inferencing. In one embodiment, the PAL network system starts with an initial network framework including a limited number of components that make up the topology, which for example may be a neural network framework that include some number of component layers, and links and nodes. The PAL system uses measured parameters about the information processing of the components, such as entropy and mutual information, to determine whether to modify the topology of the initial network structure for the purpose of creating a more efficient topology. The PAL network system will compare measures of efficacy and accuracy of the initial network structure against measures of efficacy and accuracy for the adapted network structure, and if the two network structures are probably approximate, then the systems described herein will modify the initial network structure to the more efficient adapted network structure. In one embodiment, the PAL network system evaluates candidate topologies at entropy local minima, that is, at points where the rate of change of topology entropy with respect to training iterations approaches zero (dH/dt≈0). At these stable points, the system employs a symbolic solver to compute the space of acceptable topological configurations, and then recursively determines the subnetwork components for each candidate shape within that space. While this evaluation is computationally intensive for each individual shape, the total computational burden is bounded by employing methods that have evaluations that are triggered typically only at entropy local minima rather than at every training step, and the number of such minima encountered during a typical training process is limited. Between entropy local minima, the systems and methods, typically by use of a monitor processor, continues to track information-theoretic measures but does not trigger topology evaluation or modification.

In this way the Probably Approximate Learning (PAL) network can continuously refine and improve the efficiency of an initial network structure or even a subsequent network structure such that it operates more efficiently and yet still is probably approximate to the initial network structure as to accuracy and outcome.

The below examples are provided for the benefit of one skilled in the art to help them understand more fully the systems and methods disclosed herein. However, one of ordinary skill in the art will realize that the embodiments described herein may be practiced without the use of these specific details. Further, for clarity, well-known structures and devices are shown in block diagram form to not obscure the description with unnecessary detail.

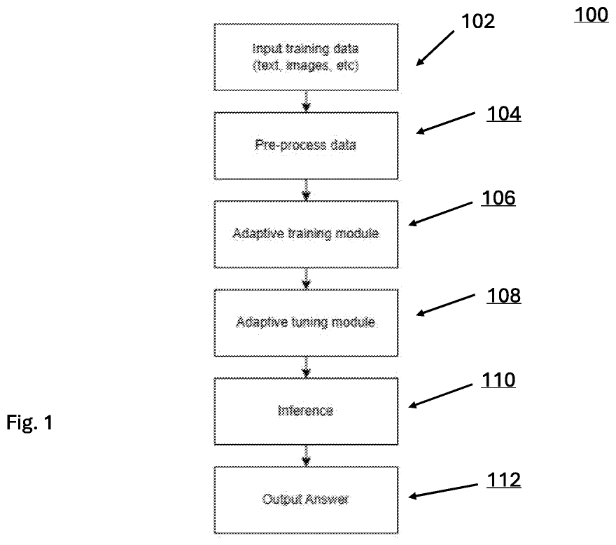

FIG. 1 provides a high-level block diagram of an end-to-end system pipeline 100 for implementing an adaptive learning network in accordance with various embodiments of the systems disclosed herein. The pipeline 100 shown in FIG. 1 processes data through a sequential series of processors, each shown in FIG. 1 as a functional block element. The depicted example pipeline 100 has a modular architecture in which each stage operates as an independently optimizable processing unit. For example, the pre-processing stage 104 may be replaced with an alternative pre-processor without requiring changes to the adaptive training processor 106, or the inference processor 110 may be independently optimized for a specific hardware target. This modularity maintains integrated functionality within the overall pipeline 100 while enabling stage-by-stage improvement. In other embodiments, other architectures other than sequential pipelines may be employed. These can include parallel pipelines and distributed architectures. The architecture used may depend upon the application being addressed and for example, if one is to develop several frameworks from a training set at the same time, a parallel architecture may be employed.

The pipeline 100 begins with input training data 102. The input training data 102 may include text, images, or other data types, and may be any training data, including for example structured or unstructured data types, suitable for training a system to make inferences and generate outputs.

The pipeline 100 will typically pre-process the training data at processor 104 and the pipeline 100 proceeds to the pre-processing processor 104. Typically, the processor 104 pre-processes the training data, often termed “raw data” by applying processes for normalization, feature extraction, and other transformations to prepare the data for network ingestion.

The pre-processor 104 connects to and sends pre-processed data to the adaptive training processor 106. The adaptive training processor 106 then applies a machine learning process to learn from the data. As will be described in more detail below, the adaptive training processor 106 will adaptively generate one or more topologies for the framework of the prediction model. The adaptive training processor 106, in one embodiment, will set or load one or more constraints, that may be aggregated. The adaptive training processor 106 employs the constraints to guide network adaptation as the topology of the framework is being constructed by the adaptive training processor 106. For example, the adaptive training processor 106 may set, or have provided to it, one or more constraints such as one or more entropy threshold constraints, one or more Kolmogorov complexity targets, one or more memory and cost constraints, power consumption constraints, and other constraints useful for helping adapt the topology of the framework to achieve a topology that provides a prediction model useful for the task, but also adapted for practical constraints, such as size, efficiency and power consumption. Typically, the adaptive training processor 106 will combine these one or more diverse constraints into a unified constraint score that determines when and how adaptive training processor 106 should adapt the topology of the framework of the model being trained. This aggregation mechanism allows the system 100 to balance competing objectives (e.g., accuracy vs. resource usage) in real-time.

As such, the adaptive training processor 106 implements a dynamic topology optimization process during the training phase. For example, and in one example embodiment, the adaptive training processor 106 may include a birth and a death mechanism for nodes in a neural network-based framework, where the acts of creating or deleting a node from the framework topology is determined, at least in part, on a measured entropy constraint or constraints. It is noted that the component generation and elimination processes described herein, referred to as “birth” and “death” in the context of nodes within a neural network topology, are operations of the PAL network system's topology modifier, they are not native operations of the underlying neural network. Conventional neural networks do not natively support node birth or death during operation; the neural network's own computational mechanisms (forward pass, backpropagation, weight updates) continue to function in the standard manner at all times. The PAL network system adds the capability for structural modification by maintaining, through the monitor, read-only channel clarity vector metadata for each node, and using the topology modifier to make discrete structural changes (adding or removing nodes and connections) based on that metadata evaluated against the loaded constraints. After each structural change, the neural network's standard training or inference processes continue on the modified topology. In this way, the PAL system modifies the structure of the computation without modifying the mechanism of the computation. In embodiments where the underlying computational framework is graph-based rather than neural, analogous operations of the topology modifier include vertex and edge creation and removal. In symbolic reasoning frameworks, analogous operations include rule generation and pruning.

As such, the adaptive training processor 106 generates from the pre-processed training data provided by processor 104 a prediction model having a framework, such as a neural network or graph-based framework, with a topology, such as the number of nodes and layers and the connections between the nodes and layers, generated by the adaptive training processor 106 that used constraints to adapt the topology.

The pipeline 100 then passes control of the prediction model generated by the adaptive training processor 106 to the adaptive tuning processor 108. The adaptive tuning processor 108 adapts the topology of the prediction model. In one embodiment, the adaptive tuning processor 108, following initial training, refines the topology of the prediction model based on performance metrics and constraint satisfaction. In one embodiment, the adaptive tuning processor 108 refines the framework of the prediction model based on entropy-related constraints or other constraints.

The pipeline 100 then employs the inference processor 110 to produce an output answer 112. The inference processor 110 handles the generation of outputs when the prediction model having the adapted topology processes new queries or test samples. The system pipeline 100 includes an output processor 112 that processes the information from the inference processor 110 to convert that information into human interpretable results.

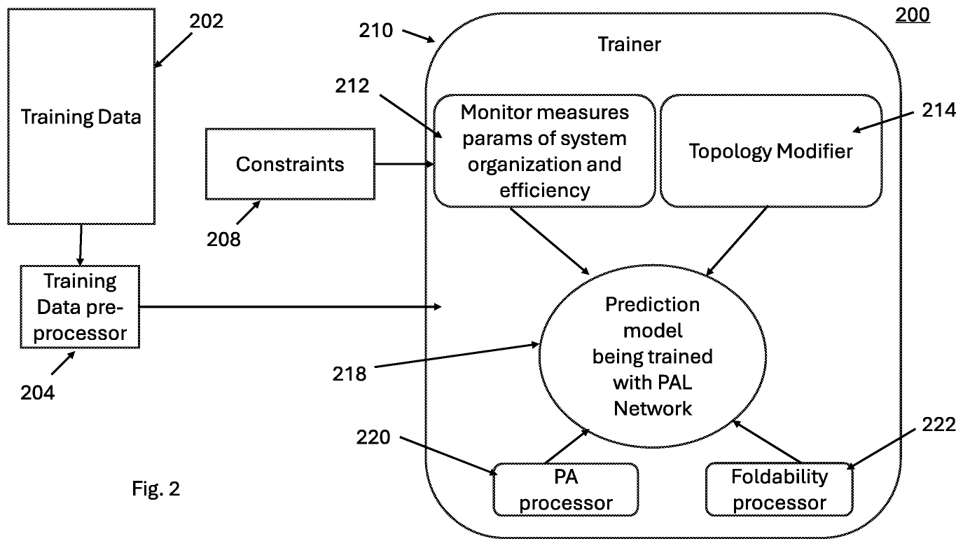

FIG. 2 depicts a functional block diagram of a PAL network 200 that will adapt the framework of a prediction model 218 during training process. In particular, FIG. 2 depicts a PAL network 200 that includes training data 202, a training data preprocessor 204, a trainer 210, constraints 208. The trainer 210 in this embodiment includes a monitor processor 212, a topology modifier 214, a probably approximate processor 220, a foldability processor 222 and a prediction model 218 that is being trained by the PAL network 200.

FIG. 2 depicts that the training data 202 is processed by the training data pre-processor 204 to get cleaned up, normalized and otherwise prepared for use by the trainer 210. The trainer 210 takes in the training data and also loads a set of constraints from constraint aggregator 208. The trainer 210 will use the training data and the constraints to develop and adapt the prediction model 218. To develop and adapt the prediction model 218, the trainer 210 includes a monitor processor 212 that is configured to measure parameters of the network/model's system organization and efficiency. The monitor 212 can compare those measured parameters against the loaded constraints, to determine whether the prediction model 218 meets the constraints, or whether the monitor 212 has measured parameters outside of the constraints 208 and modification of the framework of the prediction model 218 is to take place.

The monitor 212 may, but is not limited to, measure information-theoretic parameters. Without being bound by theory, information-theoretic parameters generally refer to quantitative measures derived from information theory that characterize properties of data representations, predictions, or internal states of a model. Examples of such parameters may include entropy, mutual information, information gain, or complexity-related measures such as Kolmogorov complexity or approximations thereof. Optionally, the monitor 212 is configured to analyze the learning progress at and across multiple system levels, which may demonstrate stabilization of information-theoretic measures at various orders, including a first, second, third, or higher derivatives. These parameters may be used to evaluate characteristics such as uncertainty in model outputs, efficiency of information representation, or structural complexity of learned representations within the model. For example, measures of entropy may be used to quantify the uncertainty associated with outputs or intermediate representations generated by a machine learning model, such as the initial prediction model 218. Lower entropy may indicate that the model produces more confident or deterministic predictions for a given input, while higher entropy may indicate greater uncertainty or variability in the model's output. In some embodiments, entropy values may be monitored or constrained during training or evaluation to encourage efficient information representation or to detect unreliable model behavior.

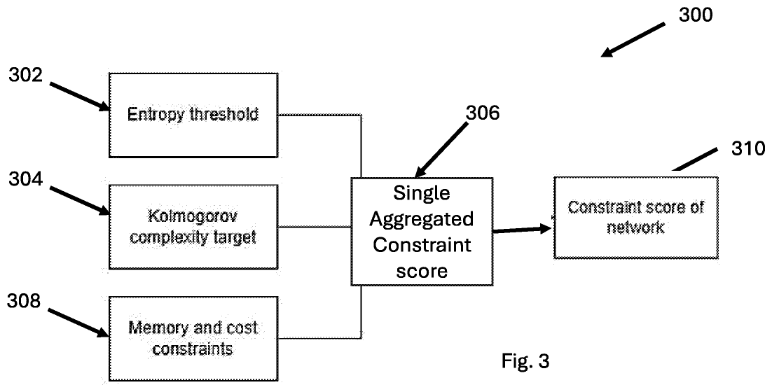

The constraint aggregator 208 may load the constraints into the trainer 210 during an initialization process. FIG. 3 presents a block diagram illustrating an example constraint aggregator 300 for a PAL network, according to certain embodiments. In particular, FIG. 3 presents an aggregator 300 that sets an entropy threshold 302, a Kolmogorov complexity target 304 and memory and cost constraints 308. As depicted in FIG. 3 these different thresholds, targets and constraints are aggregated into a single aggregated constraint score 306. The single aggregated constraint score 306 may then be used to guide or evaluate the prediction model 218. The trainer 210 can analyze the prediction model 218 to measure the parameters of efficiency and operation and yield a constraint score 312 for the prediction model 218. In this way, multiple constraints, such as entropy threshold, Kolmogorov complexity targets, and memory/cost limitations, are received as inputs. These inputs are combined into a single constraint score 306, which is then used by the trainer 210 to evaluate the prediction model 218 and adapt the prediction model 218 using the topology adapter 214. By aggregating different constraints in this manner, the system can dynamically balance competing objectives (e.g., accuracy vs. resource usage) in real time.

As depicted in the example of FIG. 3, the constraint aggregator 300 will process and aggregate multiple, in some cases competing constraints, to guide the adaptive behavior of the PAL network 200. These constraints include an Entropy Threshold 302 that in some embodiments establishes upper bounds on permissible system entropy, forcing the network to maintain information efficiency. A Kolmogorov Complexity Target 304 that sets parameters for the desired complexity of the network's information encoding, balancing between oversimplification and unnecessary complexity. Further, the depicted Memory and Cost Constraints 308 impose practical limitations on computational resources, ensuring the system remains viable for real-world deployment. The constraint aggregator 300 will process these values as inputs and combine them to produce a unified metric that triggers adaptation when thresholds are exceeded. The constraints selected for use can vary depending upon the application and needs and as such, the PAL network can further adapt the initial network structure to address theoretical and practical constraints such as the number and type of GPUs needed to run the initial network structure, the expected power consumption for that initial structure, financial costs for running that initial structure, and other practical constraints.

Example. Consider a PAL network system configured with the following example constraints for adapting a neural network topology intended for deployment on a two-GPU edge device:

|Constraint|Target Value|Weight (wᵢ)|Description |

Entropy Threshold|H≤2.3 bits/node|0.40|Max avg. Shannon entropy per node

K-Complexity Target|K≤450 bits|0.30|Approx. Kolmogorov complexity bound

Memory Constraint|≤18 GB (FP4)|0.15|Must fit target GPU memory

Power Constraint|≤300 W TDP|0.10|Edge deployment power budget

Foldability|Tile-aligned|0.05|Block dims multiple of 16

The constraint aggregator may be configured to compute a satisfaction level l(cᵢ)∈[0,1] for each constraint by comparing the measured value against the target. For example, if the monitor measures an average entropy of 2.1 bits/node against a threshold of 2.3, the satisfaction level is l(entropy)=1.0 (fully satisfied). If the memory footprint of the current topology is 22 GB against a constraint of 18 GB, the satisfaction level is l(memory)=18/22=0.818 (partially violated). The aggregated constraint score is computed as the weighted sum:

S=Σ[wᵢ·|(cᵢ)]/Σ[wᵢ].

For the example values, S=(0.40×1.0+0.30×0.85+0.15×0.818+0.10×1.0+0.05×1.0)/1.0=0.928. A non-linear transformation T(S)=S³ is then applied to amplify the impact of constraint violations, yielding T(0.928)=0.798. Because this score is below a system threshold of, for example, 0.95, the topology modifier is activated to adapt the topology, prioritizing the memory constraint (which has the lowest satisfaction level) in its modification decisions.

Returning to FIG. 2, the trainer 210 in this example loads an initial network structure to use as the initial prediction model 218. To this end, the trainer 210 can load for the prediction model 218 a network/model with a minimal starting configuration with limited nodes and connections. The trainer 210 can then measure parameters of the starting configuration of the prediction model 218. For example, the monitor 212 of the trainer 210 can measure certain characteristics of the initial prediction model 218, typically as training data is applied. For example, the monitor 212 can monitor the output distribution of each component, such as a node or layer, or branch, in the starting configuration, in response to at least some training data. The monitor 212 can make measures of entropy for the components (such as the nodes) and optionally make such measures for each component in the starting configuration. As such, the monitor 212 monitors certain operations of the initial prediction model 218 and determines various information-theoretic measures, optionally at multiple organizational levels.

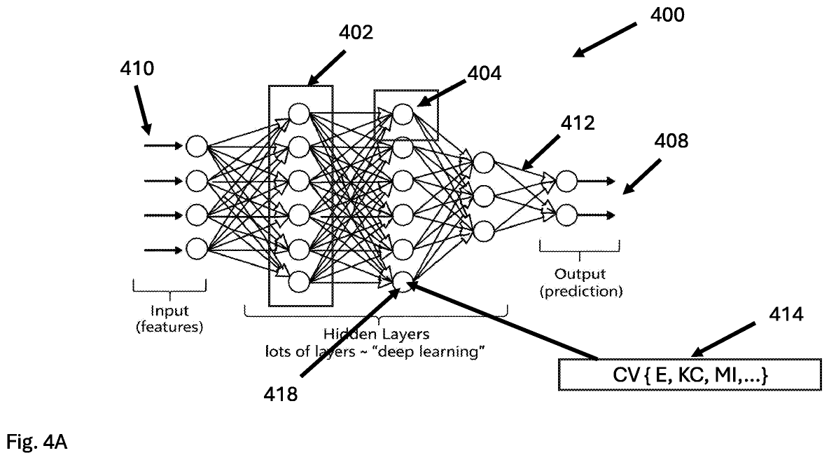

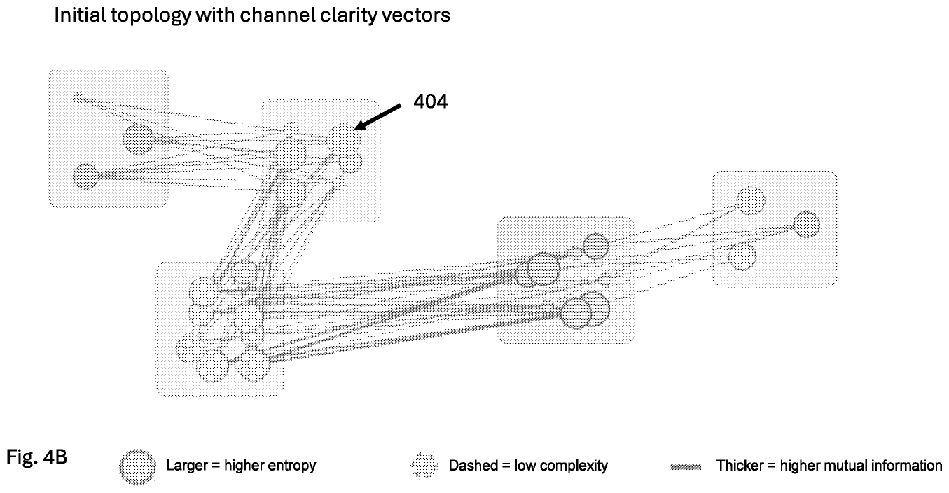

FIG. 4A depicts pictorially an example neural network framework that includes nodes and links arranged as layers that can take input and create output. The example network framework 400 represents a network framework being developed and adapted by the system 200 for FIG. 2 during training. As noted above, the monitor 212 of the trainer 210 can measure certain characteristics of a developing prediction model 218, typically as training data is applied. Specifically, FIG. 4A depicts a framework 400 configured as a neural network type structure. The depicted framework 400 includes a set of hidden layers, such as the depicted layer 402. The layers include a plurality of neurons or nodes such as the depicted node 404. The layers are interconnected by links such as the depicted link 412. The links 412 interconnect nodes 404 between the different layers 402.

FIG. 4A also depicts a channel clarity vector 414. In FIG. 4A the depicted channel clarity vector 414 is associated with one component of the framework under adaption, in this case with node 418. For purposes of clarity, FIG. 4A only depicts the channel clarity vector 414 for one node 418. However, typically, the monitor 212 will develop a channel clarity vector for multiple components of the framework being adapted. In some embodiments, the monitor 212 will develop a channel clarity vector 414 for each component of the network as well as for aggregated components of the network. Thus the monitor 212 can develop channel clarity vectors 414 for each node in the network 400, for each layer in the network 400, for groups of layers in the network 400, and for the network 400 as a whole. This allows for the monitor 212 to generate measures of efficiency for information processing across the scale of the framework 400 being developed during the training phase. In the embodiment depicted in FIG. 4A the channel clarity vector 414 measures for the component node 418 entropy, mutual information, Kolmogorov complexity, and any other measure useful for determining the efficiency of the node 418 for transferring and communicating information to its neighboring nodes. The monitor generates for the node a channel vector which can represent this information in a compact vector form. That information can be stored for each component of the network. In FIG. 4A the network is a neural network type framework, but complexity vectors of the type depicted in FIG. 4A can be developed for other framework structures. By measuring the component's efficiencies as depicted in FIG. 4A, the monitor 212 can estimate how much information is going through the present topology 400 and different components of the present topology 400 and determine, for example, where the derivative of such information propagation indicates resistance to information communication from one component, or group of components, to another. If the measures of information transference in channel clarity vector 414 fall below thresholds set by the constraints 208, such as entropy being too high across particular components, or groups of components, the trainer 210 can be guided to adapt the topology to an alternate structure that meets the constraints set out by the loaded constraint vector 208.

FIG. 4B depicts another force-directed graph visualization of an example PAL network topology during an intermediate adaptation stage. This FIG. 4B depicts that the topology can have a structure that is different from the typical layer node structure used in a neural network. In particular, FIG. 4B depicts that there are several groups of nodes which are interconnected and have a structure that is more adaptively defined than the structure of a typical neural network. FIG. 4B also depicts that each of the nodes can have measures of efficiency such as entropy values. In this FIG. 4B depiction of such measures can be shown by the size of the node, whether the node is faded, where a larger node or dark node might indicate a higher entropy, the complexity can be shown by dashed connecting lines and line thickness, and thicker lines can indicate a higher mutual information. As such, it will be apparent to those of skilled in the art that different mechanisms may be employed for encoding the information determined by the system, such as by monitor 212. In any case, in this FIG. 4B, node sizes may be understood to correspond to information throughput as measured by the monitor, and edge widths correspond to mutual information between connected components. Faded nodes and dashed connections indicate components identified by the channel clarity vectors as candidates for elimination in the next adaptation cycle.

In one particular embodiment, the monitor 212 is configured to measure and determine information-theoretic measures at multiple organization levels of the framework being adapted. In one embodiment, the monitor 212 is configured to take as input: Current system state S, Measure type M (entropy, mutual information, etc.), and provide as Output: Information measure I. The monitor 212 is configured to execute a multi-step process where:
1. For one or more component c in S:
a. Calculate information content I(c) based on implementation metrics:
   Connection weights in neural systems
   State distributions in probabilistic systems
   Rule activations in symbolic systems
   Information throughput in hybrid architectures
   Other implementation-specific metrics

Thus for one or more, or even each, component in the network being adapted, the monitor 212 measures information content based on the characteristics of that component.
2. For one or more subsystem s in S: A subsystem, as used herein, refers to a group of components that operate as a functional unit within the prediction model. For example, in a neural network framework, a subsystem may be a single layer, a group of contiguous layers (such as an encoder block or attention head group), or a functionally related set of components spanning multiple layers. In a graph-based framework, a subsystem may be a connected subgraph.
a. Calculate subsystem information measure I(s):
   For example, for entropy: I(s)=−Σ[p(c)*log(p(c))] for components c in s
   For mutual information: I(s)=Σ[p(c,d)*log(p(c,d)/(p(c)*p(d)))]
   For other measures the process will apply known process to determine the values. In the formulas above, it is noted that p(·) represents probability or normalized contribution
3. Calculate global information measure I(S):
a. Direct method: Apply global calculation across all components
b. Hierarchical method: I(S)=f(I(s₁), I(s₂), . . . , I(sₙ)); where f preserves appropriate theoretical properties
4. Return the global information measure I(S)

### Channel Clarity Vector Worked Example

Example. Consider a node n₁ in a hidden layer of a neural network topology being adapted by the PAL system. The monitor 212 is configured computes the channel clarity vector CCV(n₁) as read-only metadata about the node—the CCV is not a learnable parameter, does not participate in the forward pass or backpropagation, and is not visible to the optimizer. The node itself operates as a standard neural network node; the example CCV is the monitor's 212 annotation of the node's information-processing behavior. The example CCV comprises the following components:

Entropy: The monitor 212 examines the output distribution of node n₁ across a batch of 1,000 training samples. The monitor 212 may compute the Shannon entropy of the discretized output distribution as H(n₁)=−Σp(x) log₂ p(x)=1.87 bits. This indicates moderate uncertainty in the node's output, suggesting it is contributing meaningful discriminative information.

Mutual Information: The monitor 212 is configured to compute the mutual information I(n₁; Y) between the output of node n₁ and the target variable Y, measuring how much information the node's activation provides about the correct output. In this example, I(n₁; Y)=0.34 bits. The monitor 212 is configured to also compute the pairwise mutual information I(n₁; n₂) between node n₁ and each of its neighboring nodes, to identify redundancy. If I(n₁; n₂) is high (e.g., 0.91 bits), this indicates substantial redundancy between the two nodes, making one of them a candidate for elimination.

Kolmogorov Complexity (Approximation): The monitor 212 may be configured to estimate the algorithmic complexity of the function computed by node n₁ by measuring the compressibility of its weight vector and bias. In this example, the weight vector of node n₁, when subjected to a standard compression algorithm, compresses from 32,768 bytes to 4,120 bytes, yielding an estimated normalized complexity of \hat{K}(n₁)=4,120/32,768=0.126. A low value indicates the node's learned function is simple and potentially redundant. (Note: exact Kolmogorov complexity is uncomputable; the system uses compression-based approximations throughout.)

The channel clarity vector for this node is therefore CCV(n₁)=[H: 1.87, MI_target: 0.34, MI_neighbor_max: 0.91, \hat{K}: 0.126]. The monitor 212 passes this vector to the topology modifier 214, which compares it against the constraints. In this case, the high neighbor mutual information (0.91) combined with the low estimated complexity (0.126) suggests that node n₁ is largely redundant with a neighbor and computes a simple function. The topology modifier 214 may initiate a node death event for n₁, removing it and redistributing its connections to reduce the topology's overall entropy while preserving information flow. After this structural change, the neural network's standard training process (forward pass, backprop, weight update) continues on the modified topology without any change to the training mechanism itself.

The information-theoretic measures serve as indicators of learning efficiency and system organization of the current network/structure being analyzed by the trainer 210, with their optimization signifying improved information processing. The monitor 212 can pass these measured parameters to the network modifier 214, which can compare these measured values to the constraints 208 and determine if adaption of the initial structure of the prediction model 218 is to be made and how to make that adaption.

To this end, the modifier 214 can compare the aggregated constraint 208 cᵢ in C:
a. Calculate satisfaction level l(cᵢ)∈[0,1] where: 1 indicates full satisfaction and 0 indicates complete violation
2. Apply weighting factors w={w₁, w₂, . . . , wₙ} based on constraint priority:
a. Entropy threshold: typically higher priority
b. Kolmogorov complexity: mid-level priority
c. Resource usage: adjustable based on deployment context
Calculate weighted satisfaction: L=Σ[wᵢ*l(cᵢ)]/Σ[wᵢ]
4. Apply non-linear transformation T to L to emphasize critical violations: S=T(L). In one embodiment, the non-linear transformation is T(L)=L³ (a cubic function), which has the property of mapping satisfaction values near 1.0 to values near 1.0 (small impact for near-satisfied constraints) while mapping values below 1.0 to substantially lower values (amplifying the signal of constraint violations)
5. Return S, where S is the resulting score and determines whether adaptation is needed and guides the type of adaptation to perform. In one embodiment, the resulting score S represents the overall constraint satisfaction of the current topology. When S falls below a system-defined threshold (e.g., 0.95), the topology modifier is activated. The type of adaptation is guided by the individual per-constraint satisfaction levels: the topology modifier prioritizes modifications that address the constraints with the lowest satisfaction levels. For example, if the memory constraint has the lowest satisfaction level, the modifier prioritizes node elimination to reduce the topology's memory footprint. If the entropy threshold has the lowest satisfaction level, the modifier prioritizes structural changes that improve information efficiency.

The network modifier 214 can process the resulting score S to determine if the structure of the prediction model 218 is to be modified and how to modify. Using the example of a neural network type network/model, the network modifier can adapt the prediction model 218 by adding or eliminating components, such as nodes. For example, the network modifier 214 may determine when and where to add new architectural components.

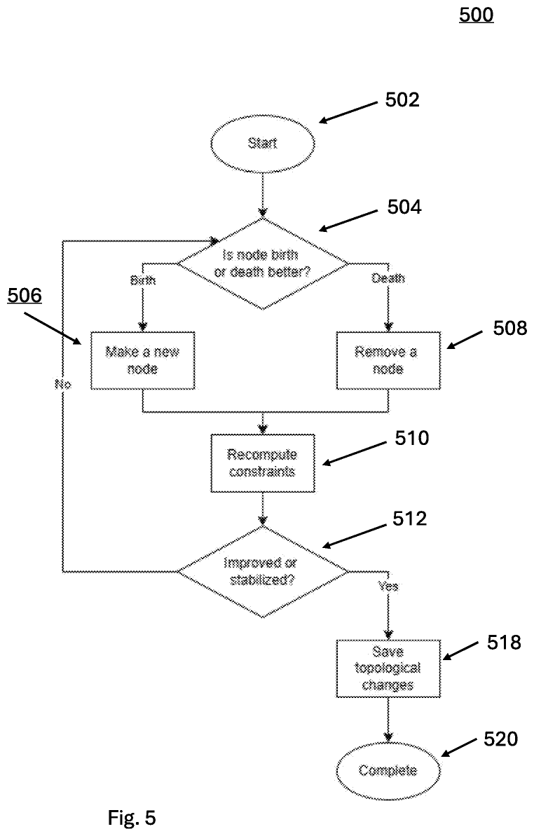

In one embodiment, the modifier 214 is configured to implement the process such as process 500 depicted in FIG. 5. FIG. 5 is a flowchart illustrating one example of an adaptive birth/death process 500 for adding new architectural components, such as nodes within the network in a neural network embodiment. The modifier 214 is configured to implement process 500 and determine whether node ‘birth” or node “death” is the more effective strategy to address the current constraints or performance issues found by measuring parameters of entropy and other information theoretic measures. If a birth event is indicated, a new node is created; if a death event is indicated, an existing node is removed. After this structural change, the system recomputes constraints (e.g., entropy or resource usage) to assess whether the network has improved or stabilized. If so, the new topology is typically saved. Otherwise, additional adjustments may be made.

More particularly, the process 500 starts at operation 502, which typically means that a comparison of the constraints against the measured characteristics found in the channel clarity vectors and computed from those vectors, indicate that structural change to the topology of the framework under adaption should take place. The process 500 proceeds to operation 504 where the system assesses whether node birth or node death is better. Depending upon the analysis, the process 500 may proceed to operation 506 where node birth is indicated and the process 506 makes a new node for insertion into the network topology being trained. Optionally if operation 504 indicates that node death is indicated, the process 500 may proceed to operation 508 where removal of a node from the network topology being trained will take place. In either case, the process proceeds then to operation 510 where the trainer will recompute the constraints found within the new modified topology of the network being trained. The process proceeds to operation 512 wherein it is determined whether the network topology as modified has improved or stabilized the performance of the structure given the constraints. If testing at operation 512 indicates improvement or stabilization has not occurred, the process reverts to operation 504 to again determine whether or not node birth or node's death is indicated. Alternatively if the operation 512 indicates that the modified network topology has improved or stabilized the efficiency of information transfer given the constraints, the process 500 proceeds to operation 518. At operation 518 the topological changes are saved. The topological changes can be saved along with information about the information processing metrics such as entropy, mutual information and other information about the components and their relative measures as compared to the constraints. And information may be stored within a memory, such as a database. And may be stored as a compressed format, or otherwise. In either case the memory is stored and can subsequently be used if necessary or if desired, typically if the system confronts input data sets indicating that the stored data structure is more suitable for use than network structures currently being adapted or used. After operation 518 the process 500 completes at operation 520. As such, the training process 500, off FIG. 5, follows the operations of the steps: Initialize and load constraints; Process training data; Compute topology entropy; Evaluate if entropy and constraints are within acceptable ranges; If not, activate the adaptive module to modify network structure; Continue until network stabilizes or completes training. This entropy-guided adaptation has the network efficiently encode information while respecting operational constraints.

Although the process 500 is described for the example of a neural network that has nodes, it will be understood that this process can be extended to other components within a neural network such as layers, or connections. For example a process similar to the process 500 can be used to determine whether a connection between certain nodes is adding to information transfer efficiency or detracting from that efficiency given the constraints of the system. Connections can be made or eliminated as necessary. Connections can be made between nodes that are neighboring, nodes that are not neighboring, nodes in different layers including non-contiguous layers, and other types of modifications that can adapt the topology of the framework being trained. In either case, it will be understood by those of skill in the art that the process 500 can be extended to other types of components other than nodes or links, and the components being added or removed will depend upon the architecture of the framework being modified.

In one particular embodiment, the network modifier 214 may be configured to determine if component addition should occur and can take as input: Current system state S, Constraint score(s) CS, Operational patterns P, and provide as output: Addition decision (boolean), Addition specification(s). The modifier 214 can be configured to determine:
1. If CS indicates constraint violation or suboptimal performance:
a. Identify candidate locations L={l₁, l₂, . . . , lₘ} based on: [how does this identification happen?]
Information measure gradients across the system,
Processing bottlenecks,
Historical performance patterns,
Domain-specific indicators
2. For each location lⱼ in L:
a. Estimate performance improvement potential ΔP(lⱼ) from adding:
Information-theoretic improvements
Accuracy or precision gains
Throughput increases
Other domain-relevant metrics
b. Estimate resource cost ΔC(lⱼ) of adding a component:
Computational overhead
Memory requirements
Energy consumption
Other implementation-specific costs.

The modifier 214 can further be configured to calculate a benefit-cost ratio: BCR(lⱼ)=ΔP(Iⱼ)/ΔC(Iⱼ
3. If max(BCR(lⱼ))>threshold τ:
a. Determine optimal component type(s) T for the selected location
b. Return TRUE and specification including location lⱼ and type(s) T
4. Otherwise:
a. Return FALSE and NULL

The component addition may involve various architectural elements depending on the implementation domain, including nodes in neural systems, rules in symbolic systems, or other structural elements.

Further, the network modifier 214 may be configured to determine when and where to eliminate an architectural component of the network being adapted and trained. To this end, the network modifier 214 may be configured to determine if and which components to remove. In one embodiment, the modifier 214 can be configured to determine whether to eliminate a component and may take as input the Current system state S, Constraint score(s) CS, Operational patterns P and provide as output: Elimination decision (boolean), and Component(s) to remove. In this embodiment, the modifier 214 may be configured to determine whether CS indicates constraint violation or optimization opportunity:
a. Identify candidate components D={d₁, d₂, . . . , dₖ} based on:
Low information or functional contribution
Redundancy with other components
Excessive resource consumption
Error introduction
Domain-specific metrics
2. For each component dᵢ in D:
a. Estimate performance impact ΔP(dᵢ) from removing component:
Information-theoretic changes
Accuracy or precision impacts
Throughput effects
Other domain-relevant metrics
b. Estimate resource savings ΔC(dᵢ) from removing component:
Computational reduction
Memory savings
Energy conservation
Other implementation-specific savings
c. Calculate cost-benefit ratio:

CBR(dᵢ)=ΔC(dᵢ)/(max(ΔP(dᵢ), ε))
where ε is a small constant to prevent division by zero
3. If max(CBR(dᵢ))>threshold τ:
a. Return TRUE and component dᵢ with maximum CBR
4. Otherwise:
a. Return FALSE and NULL

This process of the modifier 214 can apply to various types of structural components depending on the implementation domain, including nodes in neural architectures, rules in symbolic systems, or other domain-specific computational elements.

Once the modifier 214 determines the addition or elimination decisions, this modifier may implement the architectural changes to the network being adapted and trained. To this end, the modifier 214 may be configured to execute a process that takes as input: Current system state S, Addition/Elimination decision D, Target specs T and provides as output: Modified system state S′. The modifier 214 can be configured to determine:
1. If D indicates component addition:
a. Create new component(s) C according to specification T
b. Establish initial relationships with existing architecture:
Connect to relevant components based on information flow
Initialize parameters using appropriate domain heuristics
Establish feedback mechanisms as needed
c. Update architectural configuration records
2. If D indicates component elimination:
a. Identify relationships of target component(s) T
b. Redistribute critical functionality if necessary
c. Remove component(s) T from system
d. Update architectural configuration records
3. Store snapshot of previous architecture in a configuration memory
a. Compress representation using appropriate techniques
b. Store according to implementation-specific approach
Distributed storage across components
Dedicated memory structures
External storage
Other storage mechanisms
4. Return modified system state S′
This process of the modifier 214 can apply to various types of structural components depending on the implementation domain, including nodes in neural architectures, rules in symbolic systems, or other domain-specific computational elements.

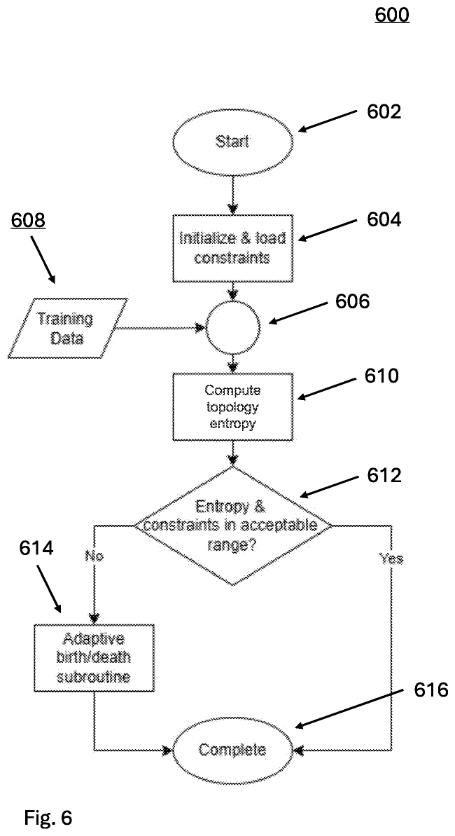

FIG. 6 is a flowchart depicting a high-level training process for the adaptive learning network, in accordance with various embodiments. Following initialization and loading of constraints, training data is provided to the system. The topology entropy is then computed, and a decision is made as to whether the current entropy and other constraints are within acceptable limits. If they are not, an adaptive module is activated to modify the network structure (e.g., by adding or removing nodes). Once the network stabilizes under the defined constraints, the process completes or proceeds to the next training iteration.

In particular, FIG. 6 depicts a process 600 that implements a decision-making process for structural modifications, like those modifications discussed with FIG. 5. In any case, at a high-level and for the example of a network structure having nodes, the process 600 determines whether node birth or death would be more effective and executes the selected action (create or remove nodes). The process recomputes constraints to assess improvement and if there is improvement or stabilization, save the topological changes. Otherwise, continues adaption until improvement or stabilization. This birth and death mechanism allows the network to grow in complexity where needed and prune redundancy where present.

More particularly, FIG. 6 depicts a process 600 That starts in operation 602. Once started, the process 600 proceeds to step 604 where it will initialize and load constraints such as the constraints depicted in FIG. 2 and discussed above. After loading constraints and initializing, where initializing often includes loading in an initial structure for a network that will be measured and tested by the system to see how to adapt it, the process 600 then proceeds to operation 606 wherein training data from 608 is provided and the initial, typically relatively minimal network structure, is trained while measuring the measures of efficiency discussed above such as entropy, mutual information and other measures of information efficiency within the components of this minimal structure. The process then moves to operation 610 wherein in this case the system computes topology entropy. This is one characteristic that can be looked at but this and multiple other characteristics can be looked at as discussed above. In any case a measure of entropy for this initial network structure or the network in general can be made and assessed in operation 610. The process then moves to operation 612 wherein the entropy and constraints are determined as being within or without an acceptable range. If the entropy for the network as compared to the constraints are within acceptable range, the process 600 moves to operation 616 where it is completed. Alternatively, if at operation 612 it is determined that the entropy as compared to constraints are outside of an acceptable range, the process proceeds to operation 614 wherein the adaptive creation and elimination or birth death subroutine discussed above takes place and the topology of this structure is changed. Subsequent to operation 614 the process 600 optionally moves to operation 616 where it is completed. Typically, the operation 614 can be an iterative process that will continue until the network structure being trained has been adapted in such a way that entropy and constraints are acceptable as determined in operation 612.

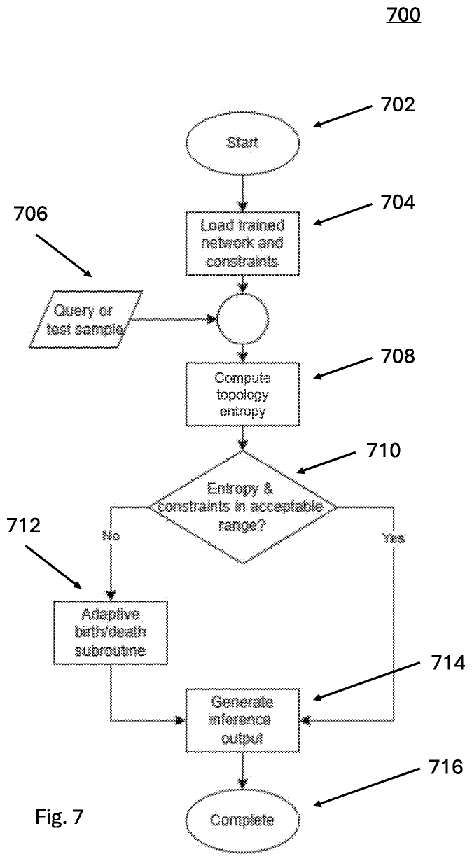

The systems and methods described herein can provide for adaption of network topology during multiple phases of operation including during training, during inferencing, validation, and other phases. FIG. 7 is a flow chart diagram illustrating an adaptive tuning process of a trained network within the learning network framework. In this process, the adaptive system receives constraint inputs (e.g., entropy thresholds or resource limits) and performance metrics for the trained network (such as error rates or subnetwork entropy). Based on these inputs, the process dynamically modifies the trained network's topology, for example, by adding (“birth”) or removing (“death”) nodes or connections, to maintain or reduce overall system entropy and satisfy user-defined constraints. This process demonstrates how adaptive tuning ensures efficient, sell-organizing behavior in both training and inference phases.

In particular, FIG. 7 depicts one example process of an adaptive tuning process during inference phase. In particular, FIG. 7 shows a process 700 that loads a trained network and constraints, processes query or test samples, computes topology entropy, evaluating if entropy and constraints are acceptable; if not, activates the adaptive module and generates inference output. More specifically, FIG. 7 depicts a process 700 that starts at operation 702. The process proceeds to operation 704 wherein it loads a trained network and constraints for that trained network. Thus the process 700 depicts a process for modifying a trained network, and thereby allows for adapting structural topological features of a trained network such as a neural network, Bayesian model, or other type of network. The process 700 also at operation 706 loads in queries or test samples of the type of data that can be used for causing the loaded trained model to generate inferences. The process 700 in operation 708 will compute topology entropy for the loaded trained network. The process for computing entropy for the network can be as described above by looking at different characteristics of the components and different larger components of the network and generating measures of entropy. And although FIG. 7 discusses at operation 708 measuring entropy, it will be understood from this disclosure that other measures including mutual information, and similar measures may be used instead of entropy or in combination with entropy. In either case measures will be taken of the network efficiency which can then be compared to constraints. As depicted in FIG. 7, at operation 710 the entropy of the trained network is checked against the constraints to see whether that entropy of the trained network is within acceptable ranges. If it is, the process 700 can proceed to operation 714 wherein the trained network can be used to generate inference outputs and the process 700 can complete at operation 716. Alternatively, if at operation 710 it is determined that the trained network topology entropy is not within the constraints set up for that trained network, the process 700 can proceed to operation 712 where adaptive steps are taken by adding or eliminating, in this case nodes through a birth and death subroutine as described above. As further described above, this process may be iterative until the network topology converges to a topology that meets the constraints. At that point the process 700 may then proceed to operation 714 to generate inferences and then to 716 and complete.

As such, unlike traditional learning systems, the PAL Network can continue to adapt its structure during inference, allowing it to optimize for specific queries or new data distributions. This can be done through the above process 700 for example, which shows how the network continues to adapt during inference as it does an inference process initialization by having the system load the previously trained network and applicable constraints. The process will use query or test sample in so that new data is presented to the network. The process will compute topology entropy by recalculating entropy based on current input. The process will check entropy and constraints are in acceptable range and reach a decision point determining adaptation necessity during inference. If needed, topology modifications occur even during inference. Then the system can generate inference output based on current input and network state.

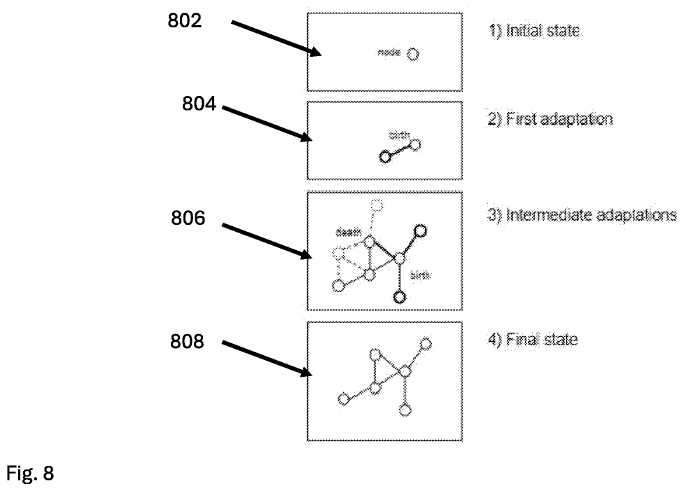

FIG. 8 depicts an illustrative example of a process of the network's topology evolving over multiple training iterations, in this case for an example of a neural network type topology. The steps show birth of new nodes or submodules, shown with bold lines and nodes, when additional capacity is needed, and death or pruning of nodes, shown with dotted lines and greyed nodes, when nodes or submodules are determined to be redundant or underperforming. By tracking these changes over time, as FIG. 8 illustrates, the system and methods described herein achieve the dynamic, self-organizing nature of the framework as it seeks to minimize entropy, for example, and satisfy user-defined constraints. In particular, FIG. 8 pictorially provides a sample view of the network's topology evolving over multiple training iterations, in accordance with various embodiments. FIG. 8 illustrates the progressive development of network structure. FIG. 8 includes block 802 that depicts the Initial State, which in this example is a minimal starting configuration with limited nodes and connections. The adaptation is further depicted in 804 that shows a first adaptation with early structural changes showing initial node birth events. In 806, there are intermediate adaptations that are more complex modifications including both birth and death events. In 808 there is a final state that shows an optimized, or constraint meeting, topology after multiple adaptation cycles. This sequence illustrates how the network evolves from simple to complex structures through successive adaptations guided by entropy minimization and constraint satisfaction.

As new topologies are adapted and generated, the systems and methods described herein may optionally check for the foldability of the adapted topology. For example, as depicted in FIG. 2, the trainer 210 may include a foldability processor 222. The foldability processor 222 may be configured to evaluate a candidate prediction model topology produced by the topology modifier against a set of hardware-specific foldability constraints. For example, the foldability processor 222 may analyze a prediction model topology similar to the topology depicted in FIG. 4B and do so considering certain constraints. These foldability constraints may include, but are not limited to, whether the connectivity pattern of the adapted topology can be represented as block-structured matrices compatible with the tensor cores or matrix units of the target processors, whether the layer dimensions of the adapted topology align with or may be padded to tile sizes supported by the target hardware, for example, multiples of 8 or 16 for common GPU tensor core configurations, whether the data flow through the adapted topology may be scheduled as a directed acyclic graph of tensor operations without exceeding the memory capacity of the target processor configuration, and whether the adapted topology, when expressed as tensor operations, would achieve a minimum threshold of arithmetic intensity sufficient to utilize the target hardware efficiently rather than being bounded by memory bandwidth. For example, in the topology of FIG. 4B, the nodes are grouped together within blocks and these blocks may represent an initial analysis by the foldability processor 222 to determine whether the overall topology may be represented as block structured matrices that could be distributed over tensor cores.

In one embodiment, the foldability analyzer processor 222 is configured to receive from the topology modifier a candidate adapted topology, such as the topology 218 of FIG. 2. The foldability analyzer processor 222 may be configured to first extract the computational graph of the candidate topology 218, identifying each operation, its input and output dimensions, and the data dependencies between operations. The foldability analyzer 222 is configured to then attempt to decompose the computational graph into a sequence of tensor operations compatible with the target processor configuration. This decomposition may include grouping nodes into layers that can be expressed as matrix multiplications, identifying operations that can be fused, and determining where data must be redistributed across processors in a multi-processor configuration. If the foldability analyzer processor 222 can produce a valid decomposition that satisfies the foldability constraints, the candidate topology is classified as foldable and is added to the space of valid network topologies. If the foldability analyzer 222 cannot produce a valid decomposition, the candidate topology is returned to the topology modifier, typically with diagnostic information indicating which foldability constraints were violated, enabling the topology modifier 214 to adjust the topology of the prediction model 218 and resubmit for analysis.

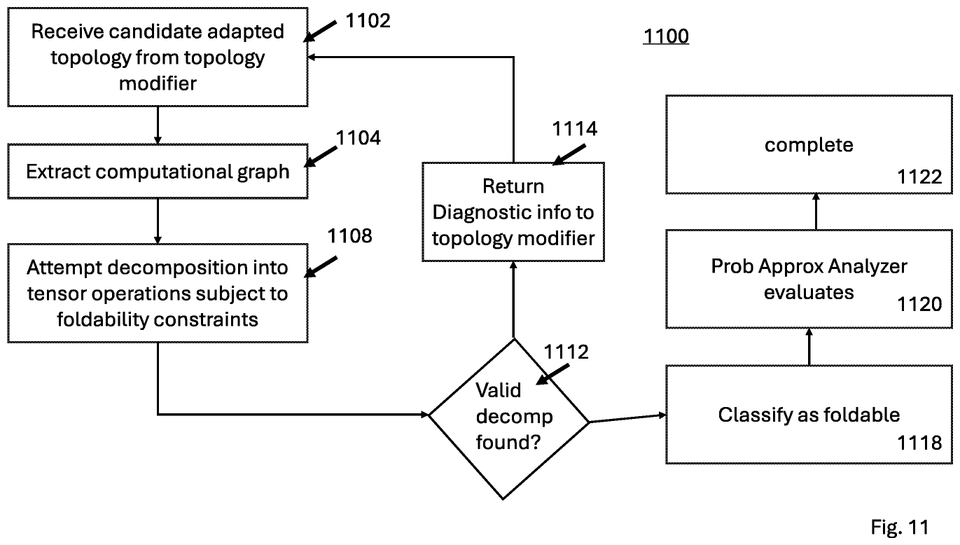

In a further embodiment, the foldability constraints may optionally be considered during the topology adaptation process itself, rather than only as a post-adaptation validation step. FIG. 11 depicts one process 1100 for checking foldability. The process 1100 begins at operation 1102 wherein the process 1100 receives candidate topologies that are adapted topologies of the type that can come from a topology modifier. After receiving the candidate topology the process proceeds to operation 1104 where it will extract the computational graph. After the graph is extracted the process then proceeds to operation 1108 where the process will attempt to decompose into tensor operations the adapted topology. Optionally, in operation 1108 the decomposition will take place subject to foldability constraints. The process then proceeds to operation 1112 where the process checks whether a valid decomposition was found. If a valid composition was found then the process proceeds to operation 1118 and classifies that topology as foldable.

The process then proceeds to the optional operation of 1120 to check whether the topology which has been found as foldable is probably approximate to the target operation for the application. If the adapted topology is both foldable and probably approximate, then the process completes at operation 1122. Alternatively at the operation that checks for a valid decomposition 1112, if the topology cannot be decomposed in compliance with constraints for example, the process will then proceed to operation 1114 and return the diagnostic information to the topology modifier for the topology modifier to continue modifying and adapting the topology and offering that topology as a candidate to this process 1100.

### Distributed Memory of Topologies

As discussed above, with reference to FIG. 2 for example, the systems and methods described herein can develop a memory of topologies suitable for solving the problem being addressed. Further, the systems and methods described herein can develop memory of topologies generated during the adaption process, regardless of whether such topologies meet other criteria, such as levels of accuracy for solving the problem being addressed. In any case, the systems and methods described herein can develop a memory of topologies and typically but optionally may associate with stored topology, information representing its measured characteristics for processing information. As such, the systems and methods described herein can include a distributed database that connects to the PAL network and stores, in an organized way and often compressed, topologies developed during the adaption processes.

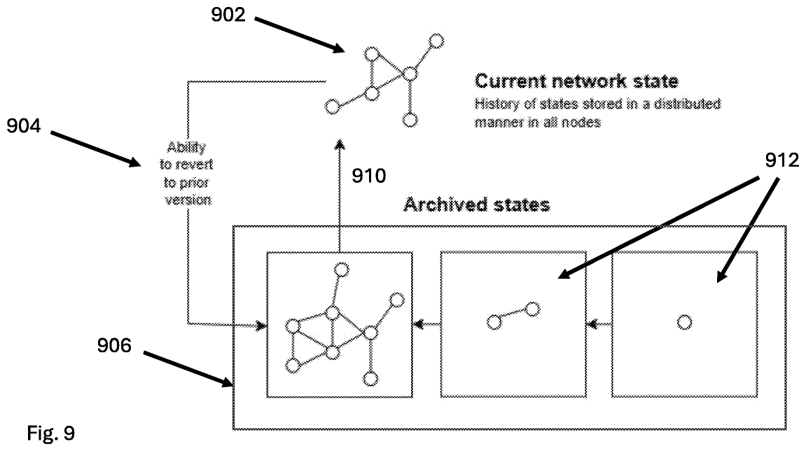

FIG. 9 is a schematic illustration of how the learning network stores and recalls previous topologies in a distributed memory system. Multiple states or snapshots of the network generated from earlier training cycles, as part of developing the database, or during other procedures, are compressed and stored in the distributed topology database. The term ‘distributed’ refers to the database storage architecture, not to distribution across nodes within the network itself. When the PAL network encounters new data or conditions resembling past states, it can retrieve relevant topology information to accelerate convergence or reduce entropy, thereby demonstrating a form of long-term structural memory. FIG. 9 illustrates how the network maintains information about previous configurations. In FIG. 9, the PAL network has a current network state 900 that can represent the active topology currently processing information. Additionally, the PAL network can have a database 906 that stores one or more archived states 912. Each state as illustrated may be a prior topology developed by the PAL network while adapting or tuning the prediction model. Typically, the archived topologies are topologies that were found during adaption and tuning and that were successful in that they met the constraints set for network performance, and typically were shown to be foldable and capable of being reduced to a set of tensor operations that can be executed across a series of processors such as GPUs. As such the database 906 represents the space of network topologies that are capable of performing in a probably approximately correct way as network topologies that are trained for the problem at hand and can provide usefully accurate inferencing and outputs. FIG. 9 illustrates that the PAL network stores and recalls previous topologies in a distributed memory system. This provides the PAL system with a form of long-term structural memory. The data stored in the database 906 may include a history of states such as a chronological record of topological variations experienced during training or tuning. Further the PAL system may be configured to revert by a process that enables the PAL network to recall and reinstate effective past configurations when current conditions warrant.

As discussed above, in alternate embodiments the PAL network may be able, depending upon constraints provided and the input and sample data being processed, to select from this database 906 one or more archived states 912 that meet the criteria for the problem being addressed, thereby reducing computational effort to find such topologies and helping to reduce entropy and converge to a useful and successful topology. This distributed memory 906 allows the PAL network to leverage successful past adaptations without maintaining complete copies of previous states, providing efficiency while preserving valuable structural information.

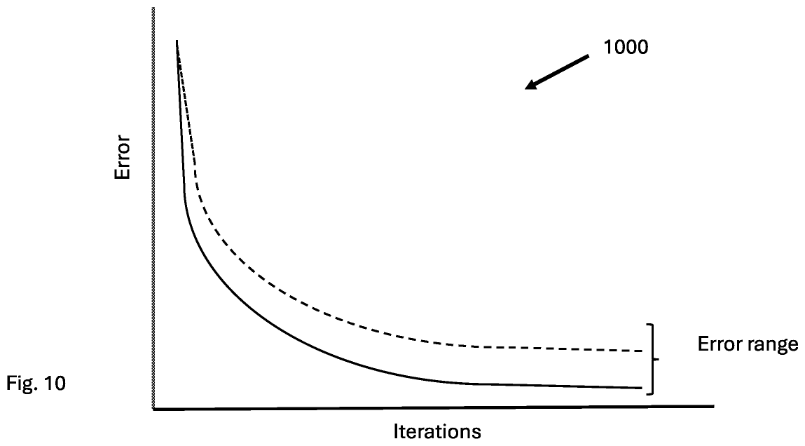

Optionally, the PAL network systems include a probably approximate analyzer, such as the PA processor 220 depicted in FIG. 2. The PA processor 220 may analyze two different networks such as the initial network model and the adapted efficient network model and determine whether the two are probably approximate. As discussed above, the PA processor, in one embodiment, may be configured to compute a representational capacity ratio defined as the ratio of the effective representational capacity of an adapted topology to the effective representational capacity of the initial topology. The effective representational capacity may be estimated using information-theoretic measures such as the total mutual information between input and output across the network, the effective number of parameters (accounting for redundancy identified by the channel clarity vectors), or the minimum description length of the function class implementable by the topology. In certain embodiments, as will be described herein, probably approximate may mean that the PA processor 220 determines that an error curve for the adapted efficient network model topology is within an acceptable range as compared to the error curve associated with the initial network model. In particular FIG. 10 depicts as an example an error curve of the type that can be generated for a learning network such as the initial network model or the adapted network model. That curve can show the error that occurs based on iterations of training the rate at which error reduces based on increased iterations of training. Further FIG. 10 depicts that a curve built from actual data generally follows the shape of the training data error curve although there is a higher rate of error. As long as there is a range of error that can be accepted, it is understood that the network model adapted or built is sufficiently probably correct to be used for the application at hand. For the systems and methods described herein, the probably approximate analyzer can look at curves similar to the curve 1000 depicted in FIG. 10 and determine whether or not the curves for the two network models are sufficiently similar that the representational capacity of the adapted efficient network model is close enough to the representational capacity of the initial network model to say that these two networks are approximately the same for the application at hand. As such the system 100 can replace the initial network model with the adapted efficient network model knowing that it is more efficient as it has been guided and adapted by the constraints set out by the constraint aggregator and the network modifier putting those constraints into place and at the same time the probably approximate analyzer provides assurance that the performance of the adapted efficient network model will be sufficiently comparable to the performance of the initial network model to make the substitution for a more efficient network acceptable and possible. The performance information of an adapted curve may also be stored in the distributed memory such as the distributed memory depicted in FIG. 9. This way an archived topology canvas associated with it a learning curve as well as other characteristic information, that will make the retrieval of that topology and replacement of an existing model with the retrieved topology more efficient.

The systems and methods described above are examples of the systems and methods disclosed herein and provided for purpose of illustration. Modifications and additions may be made without departing from the scope of this invention. Further, certain benefits and improvements are set out for illustrative purposes but other benefits will be understood from review of this disclosure. For example, it will be noted that the systems and method provide improvements, in one aspect, during generation and training. It some cases, when training one may need many elements, such as for example, nodes because one does not know a priori which nodes will be needed in the trained prediction mode, and after training with conventional systems one cannot essentially remove or add nodes after training so one cannot selectively remove unnecessary nodes. This makes neural networks inherently inefficient, and existing techniques like distillation use crude empirical approaches to capture network functionality. The systems and methods described herein provide a theoretically framed process that preserves specific pathways and information while reducing inefficiencies.

Further, in another aspect it will be understood that the systems and method described herein provide systems and methods that can provide the inferencing capability of machine learning systems but do so with greater efficiency, and in particular, systems that can continuously adapt the structural topology of a learning network across all operational phases, guided by information-theoretic measures, subject to practical constraints, and with formal assurances that adapted topologies preserve the representational capacity of the original network. Such systems and methods address the limitations of both fixed-architecture approaches and offline architecture search methods by providing a dynamic, self-modifying framework that evolves its own topology in response to measured properties of its information processing. Additionally, such systems and methods enable more efficient learning itself, not merely more efficient models, by adapting topology during training to reduce the computational cost of the learning process. Moreover, the systems and methods provide a mechanism for continuously adapting the topology of a learning network during all operational phases, including training, validation, inference, and deployment, guided by information-theoretic measures of the network's own information processing efficiency. In some embodiments, the topology which can include the arrangement of layers, the connectivity patterns between components, and the hierarchical organization of processing elements, adapts during training and use.

Example. Consider an example PAL network system that has produced an initial neural network topology with 120 billion parameters achieving, after training, a cross-entropy loss of 0.42 on a held-out test set of 10,000 samples. The adaptive process, guided by an entropy threshold and Kolmogorov complexity target, produces an adapted topology with 17.8 billion parameters. The system administrator has set the accuracy tolerance ε=0.05 (accepting up to 5% loss degradation) and the confidence parameter δ=0.05 (requiring 95% confidence).

The probably approximate analyzer generates learning curves for both topologies by evaluating each at 20 checkpoints during training (every 5% of total training iterations). At the final checkpoint, the initial topology achieves a test loss of 0.42 and the adapted topology achieves a test loss of 0.44. The bounded area divergence is computed as D=0.031, representing an average absolute difference of 3.1% across all checkpoints. The maximum pointwise divergence is 0.048, occurring at checkpoint 4 (20% of training), where the adapted topology has not yet converged as fully as the initial topology at the same stage.

The analyzer evaluates the divergence measures against the specified accuracy tolerance and confidence parameters. Based on this evaluation, the analyzer determines that the adapted 17.8B-parameter topology is probably approximate to the initial 120B-parameter topology. The adapted topology is classified as a valid member of the topology space and may replace the initial topology for deployment.

The representational capacity ratio is estimated at 0.94, indicating that the adapted topology preserves approximately 94% of the effective representational capacity of the initial topology while using approximately 14.8% of the parameters. This information, along with the learning curves, the divergence measures, and the constraint satisfaction scores, is stored in the distributed topology database.

The systems and methods described herein reference circuits, CPUs and other devices, and those of skill in the art will understand that these embodiments are examples, and the actual implementation of these circuits may be carried out as software modules running on microprocessor devices and may comprise firmware, software, hardware, or any combination thereof that is configured to perform as the systems and processes described herein. Further, some embodiments may also be implemented by the preparation of application-specific integrated circuits or by interconnecting an appropriate network of conventional component circuits. To illustrate this interchangeability of hardware and software, various illustrative components, blocks, modules, circuits, and steps have been described herein generally in terms of their functionality. Whether such functionality is implemented as hardware or software depends upon the application and design constraints imposed on the overall system. Skilled artisans may implement the described functionality in varying ways for each particular application, but such implementation decisions should not be interpreted as causing a departure from the embodiments described herein. Further, flowcharts are provided as illustrative of processes of the type that can be implemented as computer programs. These flowcharts also illustrate to the skilled user that the systems and processes described herein include inventive methods as well as apparatus, which incorporate the teachings of this disclosure.

Various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Having described above several aspects of at least one embodiment, it is to be appreciated various alterations, modifications, and improvements will readily occur to those skilled in the art. Such alterations, modifications, and improvements are intended to be object of this disclosure. Accordingly, the foregoing description and drawings are by way of example only.

1. A method for providing a self-adapting learning network, comprising
develop a prediction model having an initial topology,
measuring accuracy characteristics of the prediction model having the initial topology,
measure operating characteristics of the topology of the prediction model during training,
evaluate the measured operating characteristics to determine adaptions of the initial topology to generate an alternate topology,
modifying the topology of the prediction model to have the alternate topology,
determining accuracy characteristics of a prediction model with the alternate topology, and
determining whether the prediction model with the alternate topology may achieve similar accuracy characteristics of the prediction model with the initial topology.

2. The method of claim 1, wherein the initial topology includes a plurality of nodes and links that are arranged by operation of a self-learning training process.

3. The method of claim 1, wherein measuring operating characteristics includes measuring information-theoretic parameters, constraint satisfaction parameters, and performance parameters.

4. The method of claim 3, wherein measuring information-theoretic parameters includes measuring entropy parameters for the topology.

5. The method of claim 1, wherein measuring accuracy characteristics of the prediction model includes measuring for the initial structure a bounded measure of generalization error, a bounded measure of training sample requirements, and a bounded measure of probabilistic accuracy.

6. The method of claim 1, wherein modifying the topology of the prediction model to have the alternate structure occurs during a training phase, a validation phase, and an inference phase.

7. The method of claim 1 wherein measuring operating parameters includes measuring parameters that measure information flow across the topology and using these measurements to drive adaptation.

8. The method of claim 1, wherein adapting the topology to an alternate structure includes adding, modifying, and removing structural components of the topology in response to the determined measures.

9. The method of claim 1, further comprising aggregating and balancing multiple constraints, for controlling the adaption of the topology.

10. The method of claim 1 further comprising storing previously adapted topologies.

11. The method of claim 10, further comprising the steps of selecting, compressing, storing, retrieving, and deploying the stored adapted topologies.

12. The method of claim 10, further comprising evaluating when to revert to prior topology.

13. A method for monitoring information processing of a learning network, comprising
analyzing the learning network to identify a plurality of structural levels of the learning network
including individual components, subsystems and a global system,
monitoring information processing over these structural levels,
integrating the monitored measures of information processing made over the different structural levels to develop a network adaption process measure.

14. A method for Subsystem-Level Learning formulations, comprising
monitoring learning progress at multiple system levels, which may demonstrate stabilization of information-theoretic measures at various orders, including a first, second, third, or higher derivative.

15. A method according to claim 1, further comprising an adaptation rate control mechanisms for dynamically adjusting adaptation frequency or adaption magnitude to ensure system stability while maintaining responsiveness to changing conditions.

16. Apparatus for providing a self-adapting learning network, comprising
a trainer configured to develop a prediction model having an initial topology, a monitor processor configured to measure operating characteristics of the initial topology of the prediction model;
a probably approximate processor configured to measure accuracy characteristics of the prediction model having the initial topology, and
a topology modifier for modifying the initial topology of the prediction model to have an alternate topology.

17. The apparatus of claim 16, further including a constraint aggregator for generating constraints for guiding operation of the topology modifier.

18. The apparatus of claim 16, wherein the monitor processor generates a channel clarity vector for encoding information-theoretic measures including topology entropy, mutual information and estimated Kolmogorov complexity to characterize information transfer efficiency of the topology and the alternate topology.

19. The apparatus of claim 16, further including a foldability processor configured to determine whether the alternate topology generated by the topology modifier can be folded for execution across a structure of processors as a set of parallelized tensor operations.

20. The apparatus of claim 16, further including a probably approximate processor configured to determine if an operational metric of the alternate topology is sufficiently similar to a target operational metric.
